(19) United States
(12) Patent Application Publication
(10) Pub. No.: US 2013/0311769 A1
(43) Pub. Date: Nov. 21, 2013

(54) PUBLIC KEY ENCRYPTION OF ACCESS CREDENTIALS AND CONTENT DATA CONTAINED IN A MESSAGE

(71) Applicant: Michael William Hayes, London (GB)

(72) Inventor: Michael William Hayes, London (GB)

(73) Assignee: Electronic Shipping Solutions Ltd

(21) Appl. No.: 13/877,608

(22) PCT Filed: Oct. 4, 2011
(86) PCT No.: PCT/GB2011/051890

§ 371 Date: Jul. 25, 2013

(30) Foreign Application Priority Data
Oct. 4, 2010 (GB) 1016672.6

(51) Int. Cl. H04L 9/32; H04L 9/30

(52) U.S. Cl. CPC H04L 9/3226; H04L 9/30
USPC 713/155

(57) ABSTRACT

A method of sending data securely from a client computing device to a server computing device, the client computing device being arranged to store a public encryption key associated with the server computing device and being associated with a user, the user being a registered user on the server computing device, the method comprising: generating a message at the client computing device, the message comprising log-in data relating to the registered user for logging into the server computing device and content data; encrypting the message using the public encryption key; outputting the encrypted message for transmission to the server computing device.

### FIELD OF THE INVENTION

The present invention relates to a communication system and method. In particular, the present invention relates to a method (and associated system) for securely sending a message from a first communications/computing device to a second communications/computing device.

### BACKGROUND TO THE INVENTION

The Hypertext Transfer Protocol (HTTP) is a networking protocol for distributed, collaborative, hypermedia information systems. HTTP is the foundation of data communication for the World Wide Web/Internet. However, the HTTP is unsecured and is subject to man-in-the-middle (MITM) and eavesdropping attacks, which can let attackers gain access to website accounts and sensitive information. Hypertext Transfer Protocol Secure (HTTPS) is a combination of the Hypertext Transfer Protocol with SSL (secure Sockets Layer)/TLS (Transport Layer Security) cryptographic protocols.

TLS/SSL cryptographic protocols provide communication security over the Internet and encrypt the segments of network connections above the Transport Layer, using asymmetric cryptography for privacy and a keyed message authentication code for message reliability. The HTTPS networking protocol is designed to withstand MITM and eavesdropping attacks and is considered secure against such attacks (with the exception of older deprecated versions of SSL).

HTTPS connections are often used for payment transactions on the Internet/World Wide Web and for sensitive transactions in corporate information systems.

HTTPS is a URI (uniform resource identifier) scheme that is, aside from the scheme token, syntactically identical to the HTTP scheme used for normal HTTP connections, but which signals the browser to use an added encryption layer of SSL/TLS to protect the traffic. SSL is especially suited for HTTP since it can provide some protection even if only one side of the communication is authenticated. This is the case with HTTP transactions over the Internet, where typically only the server is authenticated (by the client examining the servers certificate).

The main idea of HTTPS is to create a secure channel over an insecure network. This ensures reasonable protection from eavesdroppers and man-in-the-middle attacks, provided that adequate cipher suites are used and that the server certificate is verified and trusted.

The trust inherent in HTTPS is based on major certificate authorities that come pre-installed in browser software (this is equivalent to saying “I trust certificate authority (e.g. VeriSign/Microsoft/ etc.) to tell me whom I should trust”). Therefore an HTTPS connection to a website can be trusted if and only if all of the following are true:
1. The user trusts that their browser software correctly implements HTTPS with correctly pre-installed certificate authorities.
2.The user trusts the certificate authority to vouch only for legitimate websites without misleading names.
3. The website provides a valid certificate, which means it was signed by a trusted authority.
4. The certificate correctly identifies the website (e.g., when the browser visits “https://example.com”, the received certificate is properly for “Example Inc.” and not some other entity).

5. Either the intervening hops on the Internet are trustworthy, or the user trusts that the protocol's encryption layer (TLS/SSL) is sufficiently secure against eavesdroppers.

The above protocol is used widely on the Internet, in particular on sites where transactions are to take place or where user log-in/registration information is exchanged.

The HTTP/SSL network protocol is also used in, for example, electronic document transaction/handling systems such as the ESS-Databridge™ system as described in WO2006/103429 and WO2008/117059.

Upon visiting a website that uses the HTTP/SSL protocols the client application (e.g. the web browser such as Google Chrome, Microsoft IE, Firefox etc.) loads the requested page and retrieves the certificate (public key) of the site. The client application then checks the validity of the certificate by checking the following items:
i) Name of the site;
ii) Validity time period;
iii) Certificate issuer (trusted list);
iv) Revocation listings (this checks if the certificate has been revoked after issuance).

If any of the above items are not valid then the user is warned. Continued navigation to the requested site is then at the explicit choice of the user.

If the site is valid then an SSL channel is established (see FIG. 1). During an initial conversation between the client 2 and server 4 sides of the system, a set of session keys are agreed which will be used for subsequent conversation.

In subsequent communications once the SSL channel has been established the client encrypts 6 all data sent to the server using the site's public key. The only key which can decrypt 8 this data is the private key which is maintained on the server side of the system only. Data sent from the server side of the system to the client side is encrypted 10 using the agreed session keys which therefore ensure only the specific client can decrypt 12 the data sent by the server.

In the SSL channel therefore encrypted data can only be read/altered by either the server or the client and the channel provides security for all the data transmitted. The SSL layer then provides security for any log-in information exchanged, any electronic documents that are exchanged and any data inputs made.

It is noted however that in certain circumstances it is not possible to establish an Internet (or HTTP/HTTPS) connection from a client computing device to a remote computing device (e.g. a server computing device). This may be a result of restrictions in a corporate Internet policy which blocks the use of Internet browsing (and therefore blocking HTTP/HTTPS traffic from a web browser) or it may be the result of an inability to establish a persistent or high bandwidth Internet connection (e.g. users that are geographically remote may have difficulty establishing an internet connection. Such users may be located in mountainous terrain or may be located on a ship at sea).

In such restricted Internet environments as described above it may, however, still be possible to send email traffic. However, the use of email where message security is concerned can present a number of challenges, such as authentication (who was the originator of the message?), confidentiality (could the information being sent and received be intercepted by a third party) and integrity (could the information being sent and received be altered by a third party?).

It is noted that the above challenges are normally addressed by the combination of the HTTPS and SSL protocols described above. In a low bandwidth, or other environment in which HTTPS traffic is blocked, the above challenges need to be met by an email client and existing solutions are often subject to a number of weaknesses.

Many email clients provide software specific implementation to allow users to sign or encrypt email messages. Encrypted messages are sent within such email clients using the private/public key encryption system. In order to send a message the sender encrypts using his private key. The message, once received at the receiver, is then decrypted using the public key of the sender. However, even where an email client supports such features there are, in practice, drawbacks, namely:
There is a high cost and effort associated with requesting and installing certificates on every user computer. Additionally, there is a cost/effort associated with supporting this configuration on a day to day basis (as people change computers or install updates to the email client (e.g. Outlook));
The private key of the sender is often stored on the sender's computer. This key can become easily compromised or replicated which would allow data to be intercepted and decrypted or possibly changed and re-encrypted;
Decryption at the receiver requires the receiver to already hold the public key of the sender. If, the receiver does not hold the public key and it needs to be emailed first then potentially it could be intercepted and used to decrypt subsequently sent secure messages;
When secure messages the email client can require the user to select between (a) encrypting and signing all emails or (b) explicitly selecting to encrypt and sign a message while drafting the message (i.e. the user selects to sign/encrypt before sending):
   In option (a) it is difficult to ensure that all recipients have been provided access to the public key in advance. If the recipient does not have the sender's certificates (public keys) then they will not be able to read the sender's messages or the sender will have to re-send as unencrypted;
   In option (b) there is a risk that the user forgets to select encryption before sending the message. If password or commercially sensitive data were included then this could seriously compromise the user's password and would leave the user's open to a man in the middle (MITM) style attack;
Any message that has been sent will still be visible in the “Sent Items” folder of the sender's email client. This message would normally be stored in an unencrypted format which would provide an opportunity to compromise the contents of the message which would be protected solely by the security configuration of the sender's machine.

It is also noted that in reality encryption and signing capabilities provided by standard email clients primarily address message integrity and prove only that the message has not been altered after encryption rather than successfully and efficiently protecting the confidentiality of the message.

An example of a secure email system is S/MIME (Secure/Multipurpose Internet Mail Extension) which provides a standard for cryptographic security within electronic messaging solutions. S/MIME functionality is built into the majority of modern email software; however major weaknesses/barriers to deploying S/MIME in practice exist. The primary weaknesses are as defined above. In addition however further drawbacks associated with S/MIME are:
It is inconsistently implemented via common email clients and not implementable at all (securely) via webmail clients;
Using S/MIME requires each client (sender) to own two private keys, one to sign and one to encrypt. Many electronic document system would not be allowed to request and issue these certificates on behalf of their users and as a result each user would have to incur the cost and effort of purchasing and installing the keys inside varying email client implementations.

It is therefore an object of the present invention to provide a system and method of sending messages in a low bandwidth environment or where a secure Internet connection cannot be established that substantially overcomes or mitigates that above mentioned problems.

### STATEMENTS OF INVENTION

According to a first aspect of the present invention there is provided a method of sending data securely from a client computing device to a server computing device, the client computing device being arranged to store a public encryption key associated with the server computing device and being associated with a user, the user being a registered user on the server computing device, the method comprising: generating a message at the client computing device, the message comprising log-in data relating to the registered user for logging into the server computing device and content data; encrypting the message using the public encryption key; outputting the encrypted message for transmission to the server computing device.

The present invention provides a method of sending content data, e.g. by email, from a user's computer (client computer) to a server computer in which the client computer uses a public key belonging to the server computer to encrypt the message to be sent. A message sent by such a method can then be later decrypted at the server device using a private key belonging to the server computer that corresponds to the public key (a public/private key pair). The method according to the first aspect of the present invention means that a client/user can send an encrypted message to a server without either needing to exchange a public key (belonging to the client) from the client to the server or needing to decide in advance to release its (client's) own public key. The user is registered at the server device, e.g. for use of certain server hosted services, and has log-in data to allow the user to log into the server device. For example, the user may have registered with the server device in order to allow HTTPS connections to be made. In the event, however, that an HTTPS connection cannot be established the method according to the first aspect of the present invention allows the user to generate and send an encrypted message to the server.

It is noted that the content data sent from the client computer may comprise a request or command to the server computer (e.g. to approve a document, to sign a document, to “amend/not amend” a document or to transfer funds from an account). The client computing device is associated with a user. In other words the client computing device may be the user's computer or the user may be utilising a third party's computer.

The encrypted message may be output via any convenient communications channel. For example, the encrypted message may be sent via email. Alternatively, the encrypted message could be sent via an SMS (Short Message Service) or MMS (Multimedia messaging service) channel or other suitable communications channel.

Conveniently the method may further comprise receiving at the client computing device an initial communication from the server computing device, the communication comprising a unique identifier. It is noted that where server and client computing devices exchange messages the unique identifier may be a convenient way of identifying a specific “conversation” that the client and server are having.

The log-in data may comprise a username and password relating to the registered user for logging into the server computing device.

Preferably, the password may be additionally encrypted before the encryption step. If the password is encrypted then a plain text version of the password does not have to be used in the generation of the encrypted message. This may therefore provide an extra layer of security.

Preferably, the message may further comprise token information to provide dual factor authentication of the user to the server computing device. The use of a dual factor token further extends the security of the system to ensure that the user must know the username and password as well as be in possession of a user assigned physical hardware token to be able to authenticate successfully.

Where a unique identifier has been previously supplied by the server computing device, the message may conveniently comprise the unique identifier.

Conveniently the client computing device may comprise an application module, the application module being arranged to request log-in data and content data from the user and to generate the message for encryption based on the requested log-in data and content data. In one example the application module may be provided by a Java based application.

Conveniently, the message generated by the application module may comprise an XML string based on the log-in data and content data. The application module may also be arranged to encrypt the generated message using the public key of the server computing device to form an encrypted message.

Preferably, the application module may be arranged to send the encrypted message to an email client for onward transmission of the encrypted message to the server computing device. The email client may either be integrated with the application module or may be separate to the application module.

Preferably, the application module may be arranged to prevent access to unencrypted log-in and content data that has been entered by the user. In other words the application module may be arranged to only output a complete encrypted message. This has the advantage that no accessible unencrypted data is held within the application module and overcomes an issue with prior art systems where unencrypted data can be held in a “Sent items” folder. The application module may be further arranged such that it deletes any entered data if the process is aborted before the message is encrypted.

According to a second aspect of the present invention there is provided a client computing device for sending data securely to a server computing device, the client computing device being arranged to store a public encryption key associated with the server computing device and being associated with a user, the user being a registered user on the server computing device, the client computing device comprising: a message composer arranged to generate a message, the message comprising log-in data relating to the registered user for logging into the server computing device and content data; an encryption module arranged to encrypt the message generated by the message composer using the public encryption key; an output arranged to output the encrypted message for transmission to the server computing device.

According to a third aspect of the present invention there is provided a method of exchanging data securely from a user at a client computing device to a server computing device, the user being a registered user on the server computing device, the server computing device being arranged to store a private encryption key relating to the server computing device and the client computing device being arranged to store a public encryption key corresponding to the private encryption key, the method comprising: generating a message at the client computing device, the message comprising log-in data relating to the registered user and content data; encrypting the message using the public encryption key; sending the encrypted message to the server computing device; receiving the encrypted message at the server computing device; decrypting the content of the encrypted message using the private key to recover the log-in data and content data; validating the identity of the user based on the log-in data; processing the content data.

According to a fourth aspect of the present invention there is provided a server arranged to receive and process an encrypted message from a client computing device, the encrypted message having been encrypted using a public key associated with the server computing device, the server computing device being arranged to store a private encryption key relating to the server computing device and comprising: an input arranged to receive the encrypted message; a decryption module arranged to decrypt the content of the encrypted message using the private key to recover log-in data and content data within the encrypted message; an identity validation module arranged to validate the identity of the user based on the log-in data; a processor arranged to process the content data.

According to a fifth aspect of the present invention there is provided a method of receiving and processing an encrypted message from a client computing device at a server computing device, the encrypted message having been encrypted using a public key associated with the server computing device, the server computing device being arranged to store a private encryption key relating to the server computing device and comprising: receiving the encrypted message; decrypting the content of the encrypted message using the private key to recover log-in data and content data within the encrypted message; validating the identity of the user based on the log-in data; processing the content data.

According to a sixth aspect of the present invention there is provided an application module for sending data securely to a server computing device, the application module being arranged to store a public encryption key associated with the server computing device and being associated with a user, the user being a registered user on the server computing device, the application module comprising: a message composer arranged to generate a message, the message comprising log-in data relating to the registered user for logging into the server computing device and content data; encryption module arranged to encrypt the message generated by the message composer using the public encryption key; output arranged to output the encrypted message for transmission to the server computing device.

It is noted that the second, third, fourth, fifth and sixth aspects of the present invention may comprise preferred features of the first aspect of the present invention.

The present invention also extends to a carrier medium for carrying a computer readable code for controlling a computing device or server to perform the methods of the first and fifth aspects of the present invention. The present invention also extends to a computing device comprising an application module according to the sixth aspect of the present invention.

### BRIEF DESCRIPTION OF THE DRAWINGS

Embodiments of the present invention will now be described, by way of example only, with reference to the accompanying drawings, in which like reference numerals are used for like parts, and in which:

FIG. 1 shows a known arrangement in which messages are exchanged between a client and server system using an HTTPS/SSL layer;

FIG. 2 shows a client-server arrangement in accordance with an embodiment of the present invention;

FIG. 2a shows an alternative arrangement for an application module in accordance with an embodiment of the present invention;

FIG. 3 shows a message generation application in accordance with an embodiment of the present invention;

FIG. 4 is a flow chart showing the process of sending and receiving a message using the arrangement of FIG. 2.

### DETAILED DESCRIPTION OF THE INVENTION

It is noted that in the following figures like numerals denote like features. The terms client computing device, client device and client side computing device are regarded as interchangeable. The client computing device may be a PC computer or alternatively a tablet (such as an iPad), a netbook, notebook or a mobile telecommunication device (“mobile phone”). The terms server computing device, server side computing device and server device are regarded as interchangeable.

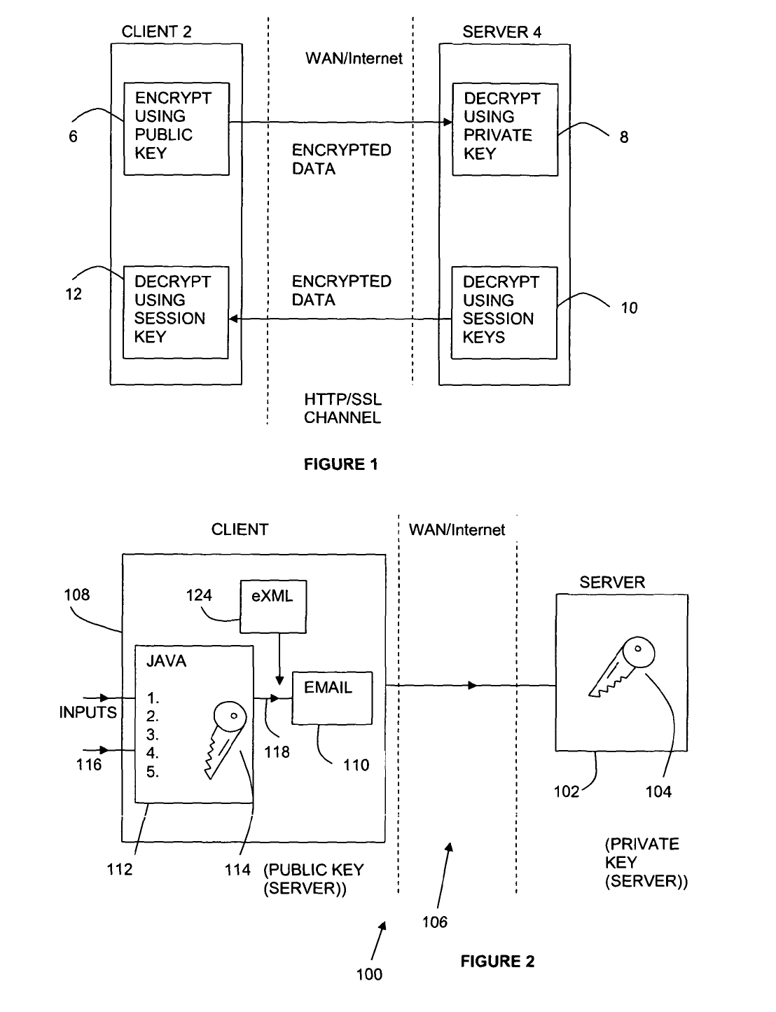

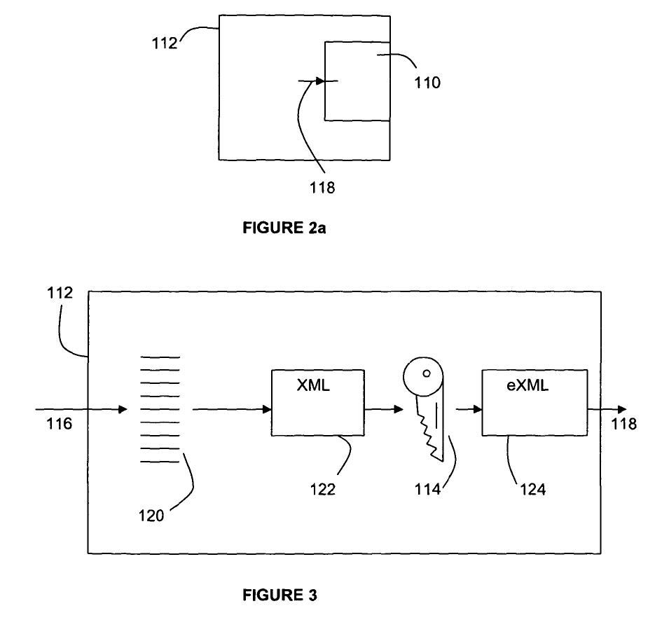

FIG. 2 shows a client-server arrangement 100 in accordance with an embodiment of the present invention. The arrangement 100 comprises a server computing device 102 which holds a server private key 104. The server private key can be used to decrypt any incoming messages that have been encrypted with the public key that corresponds to the server private key.

The server 104 is in communication via the Internet 106 with a client computing device 108. The client device 108 comprises an email client 110 and a message generation application 112 (also referred to as the application module below). The application 112 is arranged to store the server public key 114. As noted above the keys 104/114 are a private/public key pair. The computing device further comprises an input 116 arranged to allow user entered data to be supplied to the application 112. The application 112 is in communication with the email client 110 via link 118. The email client 110 is in turn configured to be able to send emails via the Internet 106, for example to the server computing device 102.

In FIG. 2 the application 112 and email client 110 are shown as separate modules within the client computing device 108. In an alternative arrangement, shown in FIG. 2a, the application 112 may comprise an integrated email client.

It is noted that the user at the client computer 108 may, in preferred embodiments, be a registered user of a service provided on the server computer 102. For example, the client computer 108 may represent a personal computer located in a home and the server computer 102 may represent a banking organisation. In such embodiments the user is expected to have been provided with a username and password in order to access services at the server 102. Additionally, the server may operate a dual factor authentication system in which the user is additionally provided with a token.

FIG. 3 shows the application 112 of FIG. 2 in greater detail. The application 112 may be a Java based application constructed using the Java Swing toolkit. The application 112 comprises an input 116 for receiving user entered data 120 and an output 118 for sending an output message to an email client (either a separate email client 110 as shown in FIG. 2 or an integrated email client module within the application 112 as shown in FIG. 2a). A copy of the server's public key 114 is stored within the application 112.

In use, the application 112 is arranged to present a user interface requesting that certain data 120 is entered in order to send a secure email based message to the server 102.

The application is then arranged to take the data 120 and generate an XML string 122 which contains the entered data 120.. The application is subsequently arranged to encrypt the unencrypted XML string 122 using the public key 114 to generate an encrypted XML string 124. The encrypted string 124 is then sent to the output 118 for onward transmission by email to the server computer 102.

It is noted that the application 112 may be a software package that is issued from the server computer to client computers. For example, in the case of a bank the application 112 may be a software package that is issued to bank account holders as part of an online banking arrangement. A bank account holder would normally interact online with the bank using an HTTP/SSL setup but in instances where this is not available the application 112 would allow them to send secure messages to the server 102 (i.e. to the bank).

Once an encrypted XML string 124 has been sent to the server the server computer 102 can extract and decrypt the encrypted XML string 124 using the private key 114 that is stored on the server side 102.

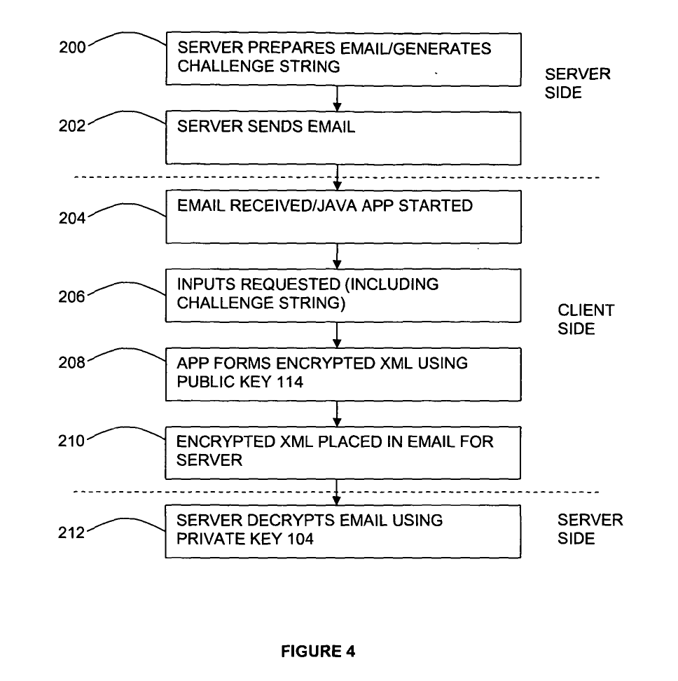

The process of sending and receiving secure messages in accordance with an embodiment of the present invention is now described in relation to FIG. 4.

The ability to send an encrypted email message in accordance with the following process flow is envisaged to be functionality that specific organisations can explicitly enable or disable depending upon local security policies. The following email functionality is regarded as complementing the ability to exchange secure communications through a web interface.

In Step 200 of FIG. 4 the server 102 prepares an outgoing communication to the client/user. This communication may conveniently be an email but could equally be another form of communication such as a fax or voice message. As part of this step the server may check if the recipient of the communication (the client side computing device 108) uses the email system/method according to embodiments of the present invention. If the recipient uses the system/method then the server 102 may generate a unique identifier (an identifier string) of, for example, alphanumeric characters (such as XC5674IP) which will act as a signing challenge.

In Step 202 the server 102 sends the communication to the client computing device 108 or to the user associated with the computing device 108.

In Step 204 the client computing device receives the communication from the server 102 and starts the application 112 in order to allow the user to compose a reply. (Alternatively, the user may receive a communication such as a fax or voicemail and start the application 112 themselves.)

Once the application 112 has been started, it asks in Step 206, for the user specified data 120 noted above.

In the registered user embodiment described above, the application 112 may request the following information:
1) the unique identifier enclosed with the communication sent in Step 200. The user may copy this identifier into the application 112. Alternatively, in the event that the received communication is an email communication the application 112 may be arranged to automatically extract the identifier from the communication;
2) a username;
3) a password. It is noted that the username and password requested by the application 112 are the same username and password that would be used to log into the server by the registered user when using a web interface;
4) a token. As noted above, the server may operate a dual factor authentication system;
5) message content. The final piece of data 120 requested by the application may be the message content itself. In the example of use of the present invention in an electronic document system the message content may be a specific action (e.g. “sign” to indicate that a contract amendment should be signed or “reject” to indicate that the user does not wish to sign). Other actions may be provided by the application 112 in the form of a drop down list in its user interface. Alternatively free form entry of data may be permitted.

In the event that the client is not a registered user of a service provided by the server 102 then the data 120 required by the application 112 may comprise the identifier, message content and optionally some other form of identification. It is noted that in yet further embodiments the identification data may be provided by means of the email address used by the client to send a message to the server (in other words the originating email address for messages received at the server 102 may constitute the identity data).

It is noted that in variants in which a user password is included as part of the input data 120 then the password may be encrypted separately using a one way encryption mechanism to ensure that the password is never human readable. This encryption mechanism for the password may be the same mechanism as is used to store the password on the server 102. In such variants the user would enter his password and the application 112 would then encrypt it using the same encryption mechanism it knows the server 102 has used to store the password. In this manner the encrypted password becomes part of the encrypted XML string 124 that the application 112 generates. When the server 102 decrypts the XML string it will recover the encrypted password which can be compared with the stored encrypted password relating to that user.

In Step 208, the application 112 forms an XML string 122 containing the inputs entered in Step 206. The XML string 122 is then encrypted using the public key 114 of the server 102 to form an encrypted XML string 124.

In Step 210 the application module 112 provides the encrypted XML string as an output 118 for incorporation by the user into an email or alternatively automatically copies it into a draft email. The email is then sent to the server computing device 102. It is noted that the content of the email has at no time been saved in draft, unencrypted format on the client computer 108 since the application 112 is arranged only to output encrypted data. It is further noted that the message content can only be decrypted using the private key 104 which only the server side systems have access to.

In Step 212 the email is received at the server side computing device 102 and the data contained within the encrypted XML string is extracted and decrypted.

In the case of the registered user embodiment described above, the following processing may occur on the server side of the system:
1) the signing challenge may be checked to ensure that it relates to a valid signing request;
2) the username and password may be checked against a user profile stored on the system at the server 102;
3) the token number may be checked to ensure it is valid. It is noted that (2) and (3) together provide dual factor authentication;
4) the email address of the sender (at the client computer 108) may be verified as the email address storied in the user profile stored on the server 102;
5) if all the above checks are successful then the action requested within the message is performed;
6) A confirmation email may then be sent to the client side computer 108 confirming the action has been completed.

It is noted that the challenge string may be used by the server 102 to identify the initial communication sent from the server to the client side computing device 108. The username, password and token are used to authenticate the identity of the user and to check the authority of the user to perform a given action.

It is noted that the method described in relation to FIG. 4 above provides an additional layer of security compared to a web based system because the email address of the email response from the client side computing device to the server 102 can also be verified as part of the authentication process.

The system and method described above may conveniently be used within an electronic document system. The challenge string sent by the server 102 may identify an action that is required in relation to documents hold on the electronic document system (e.g. documents may be released for signing or to approve amendments). The action included within the input data 120 that is input to the application 112 may then comprise a simple “Sign”/“Reject” or “approve” statement. In such a variation the electronic document system may comprise an electronic document authority on the server side of the system and the communication sent from the server side to the client side may comprise a PDF file representing the electronic documents.

In a variation to the above process the client side computing device 108 may initiate a communication with the server side system 102 without the need to receive an initial communication (and challenge string). In such a variation the user may be identified with reference to their log-in information and the message content may comprise additional instructions over and above a simple “action” statement to allow the server side system to perform an action.

The communication system and method substantially address the problems in prior art systems. The lack of an HTTPS/SSL channel is addressed by means of an encryption system that combines a public/private key encryption system and the provision of log-in information relating to a registered user who is registered on the server side of the system. The use of the server's public key at the client side of the system addresses the drawbacks of the prior art to maintain private keys on the client side of the system in order to send messages securely and also addresses the need in the prior art systems to communicate the sender's public key (from the user at the client side) to the server side of the system.

Further variations and modifications not explicitly described above may also be contemplated without departing from the scope of the invention as defined in the appended claims. For example, the method of the present invention may be used to send content data from any first computing device (client computing device, server computing device or other computing device) to a second computing device (server computing device, client computing device or other computing device respectively) where the user of the first computing device can be identified by the second computing device (by way of, for example, log-in data relating to the user for logging into the second computing device).

1. A method of sending data securely from a client computing device to a server computing device, the client computing device being arranged to store a public encryption key associated with the server computing device and being associated with a user, the user being a registered user on the server computing device, the method comprising:
generating a message at the client computing device, the message comprising log-in data relating to the registered user for logging into the server computing device and content data;
encrypting the message using the public encryption key;
outputting the encrypted message for transmission to the server computing device.

2. A method as claimed in claim 1, further comprising receiving at the client computing device an initial communication from the server computing device, the communication comprising a unique identifier and wherein the log-in data comprises a username and password relating to the registered user for logging into the server computing device.

3. (canceled)

4. A method as claimed in claim 2, wherein the password is additionally encrypted before the encryption step.

5. A method as claimed in claim 2, wherein the message further comprises token information to provide dual factor authentication of the user to the server computing device.

6. A method as claimed in claim 2, wherein the message further comprises a unique identifier that has been previously supplied by the server computing device.

7. A method as claimed in claim 1, wherein the client computing device comprises an application module, the application module being arranged to request log-in data and content data from the user and to generate the message for encryption based on the requested log-in data and content data.

8. A method as claimed in claim 7, wherein the message generated by the application module comprises an XML string based on the log-in data and content data.

9. A method as claimed in claim 7, wherein the application module is arranged to encrypt the generated message using the public key of the server computing device to form an encrypted message.

10. A method as claimed in claim 7, wherein the application module is arranged to send the encrypted message to an email client for onward transmission of the encrypted message to the server computing device.

11. A method as claimed in claim 10, wherein the email client is either integrated with the application module or is separate to the application module.

12. (canceled)

13. A method as claimed in claim 7, wherein the application module is arranged to prevent access to unencrypted log-in and content data that has been entered by the user.

14. A method as claimed in claim 1, wherein the outputting step comprises outputting the encrypted message to an email channel for transmission to the server computing device.

15. A client computing device for sending data securely to a server computing device, the client computing device being arranged to store a public encryption key associated with the server computing device and being associated with a user, the user being a registered user on the server computing device, the client computing device comprising:
a message composer arranged to generate a message, the message comprising log-in data relating to the registered user for logging into the server computing device and content data;
an encryption module arranged to encrypt the message generated by the message composer using the public encryption key
an output arranged to output the encrypted message for transmission to the server computing device.

16. A method of exchanging data securely from a user at a client computing device to a server computing device, the user being a registered user on the server computing device, the server computing device being arranged to store a private encryption key relating to the server computing device and the client computing device being arranged to store a public encryption key corresponding to the private encryption key, the method comprising:
generating a message at the client computing device, the message comprising log-in data relating to the registered user and content data;
encrypting the message using the public encryption key sending the encrypted message to the server computing device;
receiving the encrypted message at the server computing device;
decrypting the content of the encrypted message using the private key to recover the log-in data and content data;
validating the identity of the user based on the log-in data;
processing the content data.

17. A server arranged to receive and process an encrypted message from a client computing device, the encrypted message having been encrypted using a public key associated with the server computing device, the server computing device being arranged to store a private encryption key relating to the server computing device and comprising:
an input arranged to receive the encrypted message;
a decryption module arranged to decrypt the content of the encrypted message using the private key to recover log-in data and content data within the encrypted message;
an identity validation module arranged to validate the identity of the user based on the log-in data;
a processor arranged to process the content data.

18. A method of receiving and processing an encrypted message from a client computing device at a server computing device, the encrypted message having been encrypted using a public key associated with the server computing device, the server computing device being arranged to store a private encryption key relating to the server computing device and comprising:
receiving the encrypted message;
decrypting the content of the encrypted message using the private key to recover log-in data and content data within the encrypted message;
validating the identity of the user based on the log-in data;
processing the content data.

19. An application module for sending data securely to a server computing device, the application module being arranged to store a public encryption key associated with the server computing device and being associated with a user, the user being a registered user on the server computing device, the application module comprising:
a message composer arranged to generate a message, the message comprising log-in data relating to the registered user for logging into the server computing device and content data;
encryption module arranged to encrypt the message generated by the message composer using the public encryption key
output arranged to output the encrypted message for transmission to the server computing device.

20. A computing device comprising an application module as claimed in claim 19.

21. A carrier medium for carrying a computer readable code for controlling a computing device to carry out the method of claim 1.

22. A carrier medium for carrying a computer readable code for controlling a server to carry out the method of claim 18.
